(19) United States
(12) Patent Application Publication
(10) Pub. No.: US 2013/0169228 A1
(43) Pub. Date: Jul. 4, 2013

(54) MCU INTEGRATION BATTERY CHARGER/DISCHARGER

(71) Applicant: FU-I YANG, TAOYUAN COUNTY (TW)

(72) Inventor: FU-I YANG, TAOYUAN COUNTY (TW)

(73) Assignee: SAMYA TECHNOLOGY CO., LTD., TAOYUAN COUNTY (TW)

(21) Appl. No.: 13/340,763

(22) Filed: Dec. 30, 2011

(51) Int. Cl. H02J 7/00

(52) U.S. Cl. 320/110

(57) ABSTRACT

An MCU integration battery charger/discharger, and more particularly a series circuit for detecting the battery charging process and for conducting a series combined discharging process on the same battery charger. The present invention provides an MCU and a charging/discharging switch set to switch to the “separate detection charging or series-connected and combined discharging mode,” and a discharging button enables the stored electric energy be released for use by the series-connected separate detection charging circuits. Moreover, the charger can deliver DC power via tan output port to the 3C electronic products for the charging purpose. Meanwhile, the problems of conventional AA or AAA battery chargers and lithium batteries designed as a portable power are overcome, thereby enhancing the effect and safety of the charger.

### BACKGROUND OF THE INVENTION

(a) Field of the Invention

The present invention relates to an MCU integration battery charger/discharger, and more particularly to a charger designed for charging, discharging and supplying electric power to an AA or AAA rechargeable battery, and an MCU and a charging/discharging switch set are provided to integrate a circuit structure with “a separate detection charging circuit and a series-connected and combined discharging circuit.”

(b) Description of the Related Art

As portable 3C electronic products become increasingly more popular, the demand for batteries becomes increasingly higher as well. A disposable battery (or a primary battery) is discarded after use, not only increasing the cost, but also causing environmental pollutions. Therefore, a rechargeable battery (or a secondary battery) has a higher consumption than that of the primary battery since the rechargeable battery can save costs and reduce contaminations of waste batteries.

At present, the rechargeable battery includes lithium-ion (Li-ion) battery, nickel metal hydride (Ni-MH) battery, nickel cadmium (Ni—Cd) battery and the rechargeable alkaline battery, and these batteries are also known as secondary batteries. Recently, a lithium battery with an organic electrolytic unit is used extensively in portable electronic devices due to its features of high-capacity density, low temperature, and stable storage.

However, the lithium battery still has the following drawbacks in its use:

1. The lithium battery usually comes with a different specification for each of the electronic products. Even for the electronic products of the same brand, such as the Nokia mobile phones, there are tens of models of the lithium batteries, and thus causing tremendous inconvenience and trouble to users.

2. The lithium battery contains an electrolytic unit, and there is a safety concern such as possible explosion occurred when a current is passed.

3. Most of the present portable powers use a built-in lithium battery as an energy storage unit, but it generally does not come with a standard size for general electronic consumer products. As a result, the fully charged battery cannot be used alone when it is removed. Even though it can be removed, there are so many specifications of the lithium batteries, and such application is impractical.

Compared with the lithium battery, although the secondary battery such as the nickel metal hydride (Ni-MH), nickel cadmium (Ni—Cd) or alkaline rechargeable secondary battery has an energy storage density less than that of the lithium battery, yet its widely used AA or AAA battery sets an industrial specification, which is the main reason of its popularity up to now. However, its use still has the following insufficiencies:

1. As shown in FIG. 1, which illustrates a charging circuit of a conventional parallel charger, the batteries B1˜B4 connected in parallel are charged by the charging circuit. The advantage lies in that each of the batteries obtains a roughly the same charging voltage. The user can be free of the problem with batteries that are overcharged or undercharged. However, the disadvantage of the parallel charging mode is that the batteries can't be rapidly charged. Each of the batteries has only 1.2˜1.5V. When they are used/discharged for the 3C electronic products, they have to be connected in series for obtaining the DC voltage of (1.2V˜1.5V)×4=4.8V˜6V. It is complicated to discharge the parallel-connected batteries in a series way. Moreover, the problems such as power consumption, voltage difference and overheat have to be overcome.

2. As shown in FIG. 2, which illustrates a charging circuit of a conventional series charger, the batteries B₁˜B₄ connected in series are charged by the same charging circuit. The advantage is that the structure is simple and the batteries can be rapidly charged. However, this application may have drawbacks such as overheat, leak and undercharge.

3. In order to improve the above-mentioned charging circuit, the applicant of the invention disclosed a solution of U.S. Pat. No. 6,784,638 “Series Charger with Separate Detection of Batteries” with which a plurality of batteries connected in series can be charged. In addition, a control IC and a separate detection circuit are employed to conduct the detection control of each battery. In this way, the problems of the series charger and the parallel charger may be eliminated. By use of this series charger with separate detection of batteries, the batteries each can be charged and detected if they are fully charged. However, it is not possible as well to discharge the batteries in a series mode for the 3C electronic products. This requires further improvements.

### SUMMARY OF THE INVENTION

It is a primary object of the present invention to provide an MCU battery integration charger/discharger, and more particularly a series circuit for detecting the battery charging process and for conducting a series-connected and combined discharging process on the same battery charger. Whereby, the stored electric energy can be released for use by the series-connected separate detection charging circuits. Moreover, the charger can deliver DC power via the interface to the 3C electronic products for the charging purpose. Meanwhile, the problems of conventional AA or AAA battery chargers and lithium batteries designed as a portable power are overcome, thereby enhancing the effect and safety of the charger.

Another object of the present invention is to provide an MCU integration battery charger/discharger, serving as a charger when a battery is charged in an independent separate charging mode and removed from the charger for the use by an electronic product, or serving as a discharger when a charging/discharging switch set is switched to a series-connected and combined discharging mode, and a stabilized DC power is outputted for charging a portable electronic product, or serving as an adaptor by supplying a DC charging power when there is no battery placed in the charger or the power of an electronic device is low. In addition, the battery charger becomes a portable power when is carried Out, such that when the power of an electronic device is low, the charger can serve as a backup secondary battery. Even one alkaline primary battery can be placed in the battery charger for the discharging, and thus the battery charger also serves as an emergency power supply.

In order to achieve the above-mentioned objects, the invention includes:

a casing, containing a charging component, and having a charging base disposed on a surface of the casing, a plurality of charging compartments formed in the charging base for placing a plurality of AA or AAA batteries respectively, and an end of the charging compartment being a positive terminal, and the other end of the charging compartment being a negative terminal, thereby creating a charging circuit, and the casing having a plug connectible to an external power source;

a charging circuit, including an exchange power source for converting an AC or DC power to a DC power and supplying a reference voltage source to a charging control unit, and a current control unit and a voltage control unit being interposed between the charging control unit and the exchange power source, thereby creating a charging circuit for charging the batteries in the charging base;

each charging circuit of the batteries within the charging base being connected in parallel with a switch element, and an anti-adverse-current element being interposed between the switch element and the positive terminal of the battery;

a charging/discharging switch set provided for switching the charging circuits into the charging mode or the discharging mode, and the charging/discharging switch set having a number n−1 of switching units (SW₁˜SWₙ₋₁) corresponding to the charging circuits n in the charging base such that a switching unit is respectively interposed between two charging circuits, and wherein the last switching unit (SWn) of the charging/discharging switch set is an independent charging/discharging control switch, and wherein each of the switching units (SW₁˜SWₙ) has three contacts a, b, c, and wherein the contact a of the switching units (SW₁˜SWₙ₋₁) is electrically connected to the switch element of the corresponding charging circuits and to the front end of the anti-adverse-current element of the next charging circuits, and wherein the contact b is electrically connected to the positive terminal of the battery of the next charging circuit, and wherein the contact c is electrically connected to the negative terminal of the battery of the corresponding charging circuit, and wherein the contact a of the switching unit (SWₙ) serving as the charging/discharging control switch is not only a ground connection but a charging control terminal, and the contact b is a discharging control terminal connecting to a power control terminal (V_{DD}), and the contact c is connected to the charging control unit by a first connecting wire;

a voltage regulator circuit, being coupled to a positive terminal of the first charging circuit/compartment in the charging base for boosting or stepping down the series-connected and combined discharging current of each battery to a predetermined DC voltage;

an output port, coupled to an output terminal of the voltage regulator circuit;

a feedback current, being fed back discharging current of a part of the battery from the output terminal of the charging base to the reference voltage source and the charging control unit by a second connecting wire while the battery is discharging; and

a discharging button, exposed from a surface of the casing, and electrically connected to the charging control unit while the charging control unit is connected to the voltage regulator circuit by a third connecting wire for controlling the discharging current outputting the voltage regulator circuit to the output port;

whereby, when the battery is set in the charging base, the charging/discharging control switch is in a LOW voltage level, and the charging control unit controls n sets of switching units (SW₁˜SWₙ) to synchronously turn each contact c and each contact a ON, such that each battery of the charging circuit is in a separate detection charging mode, and when the each battery is fully charged, the charging/discharging control switch is in a HIGH voltage level, and the charging control unit controls n sets of switching units (SW₁˜SWₙ) to synchronously turn each contact c and each contact b ON, such that each battery of the charging circuit is in a series-connected and combined synchronous discharging mode, and the discharging button is provided for controlling the ON/OFF of the discharging current from the voltage regulator circuit.

According to the above-mentioned technical features, the charging base has n sets of charging circuits, and n is equal to 2, 4 or 8, and the n−1 sets of the switching units (SW₁˜SWₙ₋₁) corresponding to the charging/discharging switch set is equal to 1 set, 3 sets or 7 sets, and the 1 set, 3 sets or 7 sets plus the last n^{th} set of independent switching unit (SWₙ) form the charging/discharging control switch.

According to the above-mentioned technical features, the charging/discharging switch set is constructed as an electronic type switch which is comprised of a MOSFET or a logic circuit.

According to the above-mentioned technical features, the exchange power source is externally coupled to a DC To DC power supply for supplying the power to the output port.

According to the above-mentioned technical features, a current detector circuit is composed between the current detection component and the current control unit, and the current detector circuit is electrically connected to the current control unit.

According to the above-mentioned technical features, a discharging (enable) switch is built in the voltage regulator switch.

According to the forgoing techniques, the present invention is provided and integrated with the MCU and the charging/discharging switch set for constituting a circuit structure featuring an “separate detection charging and series-connected and combined discharging mode” without increasing the volume of the charger so as to overcome the problems of conventional chargers for nickel metal hydride batteries and nickel cadmium batteries and the problems of lithium batteries designed as a portable power, and to enhance the effect and safety of the charger.

### BRIEF DESCRIPTION OF THE FIGURES

FIG. 1 is a charging circuit of a conventional parallel charger;

FIG. 2 is a charging circuit of a conventional series charger;

FIG. 3 is a perspective view of the present invention;

FIG. 4 is a schematic circuit diagram showing series-connected charging in accordance with the present invention;

FIG. 5A is a schematic circuit diagram I of the present invention in a separate detection mode;

FIG. 5B is a schematic circuit diagram II of the present invention in a separate detection mode;

FIG. 5C is a schematic circuit diagram III of the present invention in a separate detection mode;

FIG. 5D is a schematic circuit diagram IV of the present invention in a separate detection mode;

FIG. 6 is a schematic circuit diagram showing four series-connected discharging circuits in accordance with the present invention;

FIG. 7 is a schematic circuit diagram showing battery discharging feedback current in accordance with the present invention;

FIG. 8 is a schematic circuit diagram showing the power supply current in accordance with the present invention;

FIG. 9 is a schematic circuit diagram showing both charging current and power supply current in accordance with the present invention;

FIG. 10 is a schematic circuit diagram showing parallel-connected charging in accordance with the present invention;

FIG. 11 is a schematic view of an application of the present invention, showing a charger connected to an external power source;

FIG. 12 is a schematic view of an application as a charger in accordance with the present invention;

FIG. 13 is a schematic view of an application as a discharger in accordance with the present invention;

FIG. 14 is a schematic view of an application as an adaptor in accordance with the present invention;

FIG. 15 is a schematic view of an application as an adaptor and a charger concurrently in accordance with the present invention; and

FIG. 16 is a schematic view of an application as a portable power in accordance with the present invention.

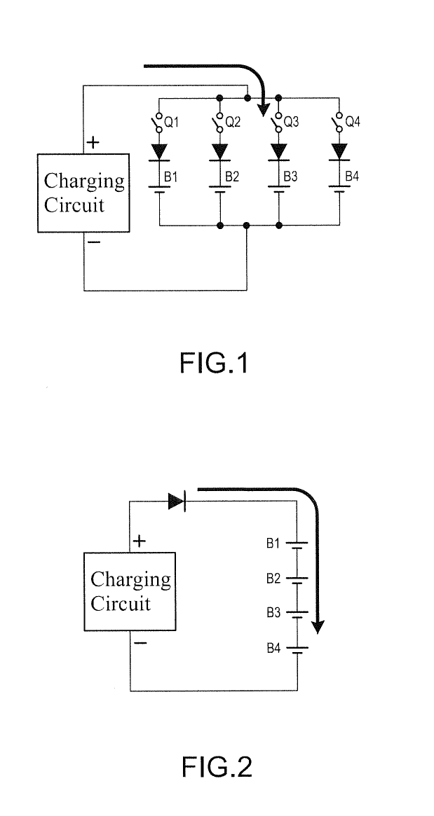

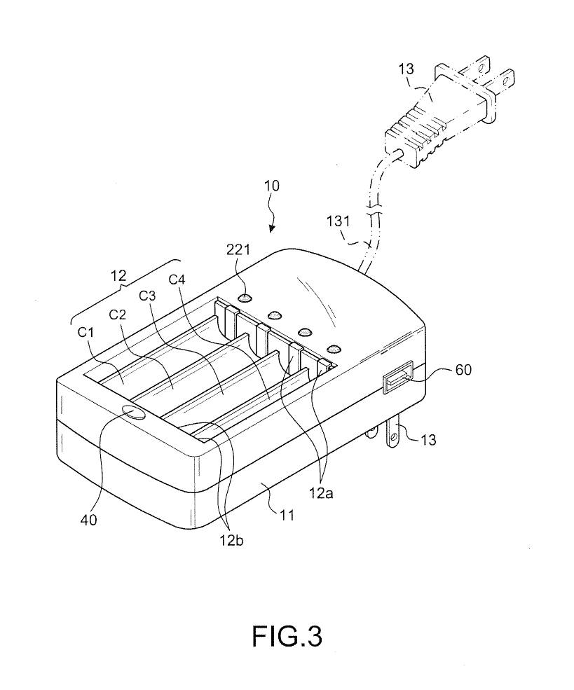

### DETAILED DESCRIPTION OF THE PREFERRED EMBODIMENT

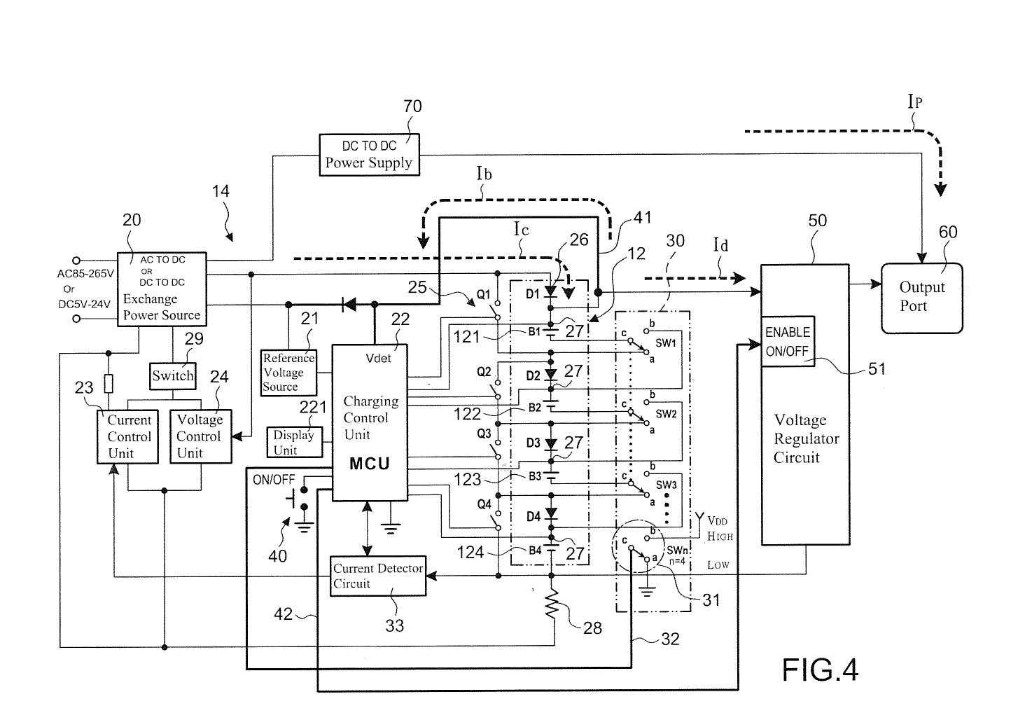

With reference to FIG. 3 for a perspective view of a battery charger 10 of the present invention, the charger 10 comprises: a casing 11, for containing and covering charging components (such as a switching power supply and a charging circuit), and a charging base 12 disposed on a surface of the casing 11 and having a plurality of charging compartments provided for placing a plurality of AA or AAA batteries B₁˜B₄ therein. In this preferred embodiment, there are four charging compartments C₁, C₂, C₃, C₄, but the invention is not limited to such quantity only. In a small charger, there are two charging compartments. Four charging compartments are used as an example for the description of a preferred embodiment and the illustration of its related drawings as follows. The casing 11 further comprises a plug 13 connectible to an external power source 80, wherein the plug 13 of this preferred embodiment is foldable and disposed at the bottom of the casing 11. Of course, an external power cable 131 or a replaceable plug 13 can be used for connecting the external power source 80 instead.

The charging base 12 as shown in FIG. 3 may further have an external cover. In addition, the casing 10 includes a plurality of display units 221 which may be LEDs for displaying a charging status of each charging compartment C₁˜C₄. Each charging compartment has a positive terminal 12a and a corresponding negative terminal 12b.

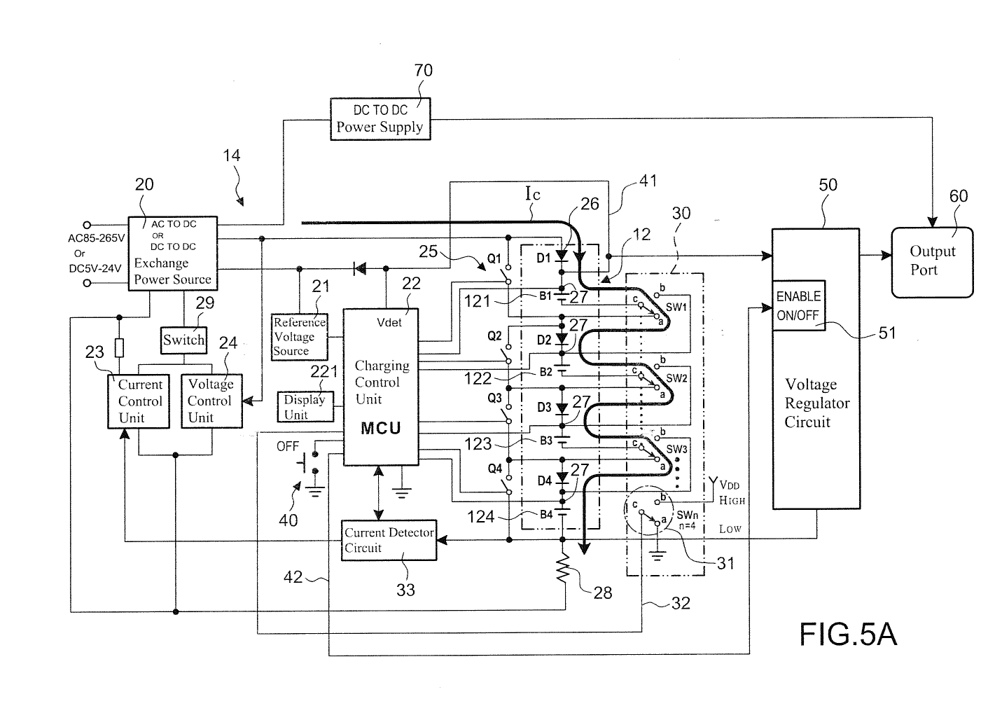

With reference to FIG. 4 for a schematic circuit diagram of a preferred embodiment of the present invention, most of the components in this circuit structure are contained in the casing 11, and only a small number of components are exposed from a surface of the casing 11, and the circuit structure comprises the following elements:

A charging circuit 14 includes an exchange power source 20 for converting an AC or DC power to a DC power and supplying a reference voltage source 21 to a charging control unit 22, thereby creating the charging circuit 14 for charging the batteries B₁˜B₄ in the charging base 12. The charging control unit 22 is an MCU of a microcomputer, and each component of the charging circuit 14 is operated by executing a predetermined sequence of procedures.

A current control unit 23 and a voltage control unit 24 are interposed between the input terminal of the charging control unit 22 and the exchange input power source 20, and a switch 29 is installed between them. The charging circuit 14 composed of the foregoing components is a prior art, and thus will not be described here.

A current detection component 28 is coupled to a negative terminal 12b of the charging base 12, and the current detection component 28 can be a resistor R and coupled to the current and voltage control units 23, 24 for detecting current by the charging of the charging base 12 and using it as a voltage feedback current control to make adjustments.

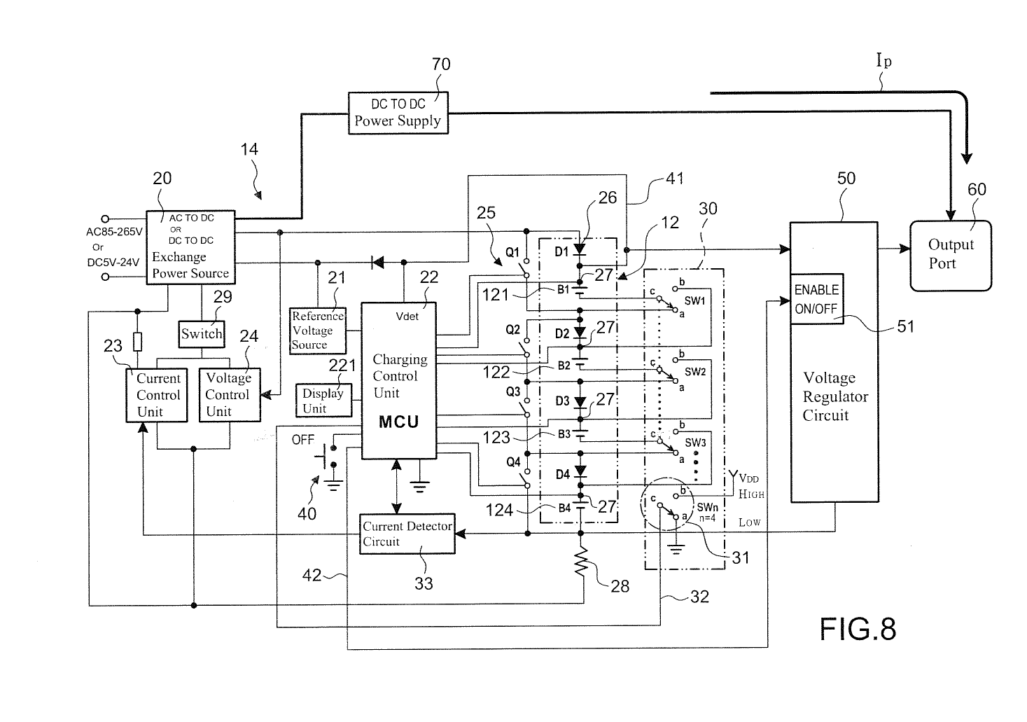

As shown in FIG. 3, the charging compartments C₁˜C₄ of the charging base 12 are connected in parallel. As shown in FIGS. 4 to 9, the batteries B₁˜B₄ in the charging base 12 are connected in series. However, the batteries B₁˜B₄ as shown in FIG. 10 are connected in parallel. Back to the FIG. 4, the positive and negative terminals of each charging compartment create a charging circuit. There are four charging circuits 121˜124 provided in this embodiment. Each of the charging circuits 121˜124 is connected in parallel with a switch element 25 such as MOSFET, but should not be limited thereto. In other words, four MOSFETs Q₁˜Q₄ are provided in this embodiment. An anti-adverse-current element 26 is interposed between the switch element 25 and the positive terminal of the battery. The anti-adverse-current element 26 can be a diode or MOSFET. According to the embodiment, four diodes D₁˜D₄ serve as the anti-adverse-current element 26.

The charging control unit 22 separately applies a terminal voltage to the positive terminals of the batteries of the charging circuits 121˜124 for the purpose of detection. As shown in FIG. 4, the point to detect the terminal voltage is marked with 27. The detection points 27 are electrically connected to the charging control unit 22 such that the switch elements 25 connected in parallel with the charging circuits 121˜124 are switched in the ON-position when the batteries B₁˜B₄ are fully charged. In this way, the charging current I, can be used for a further (or downward) charging process. As a result, each batteries B₁˜B₄ in series can be separately detected by the invention if they are fully charged.

The series charging circuit in accordance with the invention differs from the prior art in that the batteries each can be separately detected if they are fully charged when they are charged in a series-connected state and that they are changed into the discharge mode when they are fully charged. In order to achieve these effects, a circuit arrangement specially designed is required. According to the present invention, an MCU and a charging/discharging switch set 30 are employed to achieve the expected effect of series combination discharge. In other words, the negative terminal of the battery B₁ of the first charging circuit 121 in accordance with the present invention is not directly connected to the positive terminal of the battery B₂ of the second charging circuit 122. This also applies to the third and fourth charging circuits 123, 124. According to the invention, the charging/discharging switch set 30 has to be interposed between the charging circuits 121˜124 for conducting different switching functions.

The charging/discharging switch set 30 in accordance with the present invention is constructed as an electronic type switch which can be a MOSFET or logic circuit while the charging control unit 22 is used to control the ON/OFF state of the charging/discharging switch set 30. The contacts a, b, c of the switching units SW₁˜SW₄ of the charging/discharging switch set 30 have the same connection way and the same synchronous switching control way. That is, the last switching unit SW₄ is used as a charging/discharging control switch 31.

FIG. 4 illustrates that the charging/discharging switch set 30 has four switching units SW₁˜SWₙ, n=4. The number n of the switching units SW₁˜SW₄ depends on the charging circuits 121˜124. For example, there are n switching units SW₁˜SW₄ correspondingly when n charging circuits 121˜124 are provided. Moreover, the n-^{th} switching unit SWn is the charging/discharging control switch 31. As a result, more than four charging circuits can be provided in the invention. That is, there can be eight charging circuits.

The charging/discharging switch set 30 is internally provided with a number n−1 of switching units SW₁˜SWₙ₋₁ corresponding to the charging circuits 121˜12n, n=4 such that a switching unit is respectively interposed between two adjacent charging circuits, for example between the first and second charging circuits 121˜122 while the last switching unit SWₙ of the charging/discharging switch set 30 is an independent charging/discharging control switch 31. Moreover, each of the switching units SW₁˜SWₙ has three contacts a, b, c. The contact a of the switching units SW₁˜SWₙ₋₁ is electrically connected to the switch elements Q₁˜Q₃ of the charging circuits 121˜123 and the front end of the anti-adverse-current element D₂˜D₄ of the next charging circuits. The contact b of the switching units SW₁˜SWₙ₋₁ is connected to the positive terminal of the battery of the next charging circuit. For example, the switching unit SW₁ is connected to the positive terminal of the battery B₂, and the switching unit SW₃ is connected to the positive terminal of the battery B₄. In addition, the contact c of the switching units SW₁˜SWₙ₋₁ is electrically connected to the negative terminal of the battery of the corresponding charging circuit 121˜123. The negative terminal of the last charging circuit 124 is grounded. A preferred embodiment of the present invention may have n sets of charging circuits in the charging base, wherein n is equal to 2, 4 or 8, and n−1 sets of switching units SW₁˜SWₙ₋₁ corresponding to the charging/discharging switch set 30 include 1 set, 3 sets or 7 sets, and the last n^{th} set of independent switching unit SWₙ may be added to the 1 set, 3 sets or 7 sets to serve as the charging/discharging control switch 31.

A feedback current I_{b} is a discharging current I_{d} of a part of the batteries for feeding back from the output terminal of the charging base 12 to the reference voltage source 21 and the charging control unit 22 by a second connecting wire 41 while the battery is discharging.

A discharging button 40 is exposed from a surface of the casing 11 and electrically connected to the charging control unit 22 while the charging control unit 22 is connected to a voltage regulator circuit 50 by a third connecting wire 42 for controlling the discharging current I_{d} outputting from the voltage regulator circuit 50 to the output port 60. In this preferred embodiment, the voltage regulator circuit 50 is a synchronous buck/boost DC/DC converter, and the buck/boost IC technology of this sort has been used extensively, and can provide a stable and accurate voltage output, and its internal circuit is a prior art and thus will not be described in details here.

Since four pieces of nickel metal hydride/cadmium secondary batteries B₁˜B₄ connected in series can only provide a voltage of 1.2Vx4=4.8V which is still below the standard USB power output of DC 5.0V, therefore, it is necessary to step up the voltage. Since the voltage of the alkaline primary battery is 1.5V, and four of them provide a total voltage of 6V, therefore the discharging current is different from the secondary battery and requires stepping down the voltage from 6V to 5V. On the other hand, the present invention adopts the foregoing voltage regulator circuit 50 that can discharge, step up, step down or regulate the voltage for different batteries, so as to assure that the electric power supply from the USB output port 60 has a stable and accurate voltage.

When the batteries B₁˜Bₙ are set in the charging base 12, the charging/discharging control switch 31 is in a LOW voltage level, and the charging control unit 22 controls n sets of switching units SW₁˜SWₙ to synchronously turn each of the contacts c and each of the contacts a ON, such that the battery B₁˜Bₙ on each charging circuit 121˜124 is in an independent separate charging mode. When the batteries B₁˜Bₙ are fully charged, the charging/discharging control switch 31 is in a HIGH voltage level, and the charging control unit 22 controls n sets of switching units SW₁˜SWₙ to synchronously turn each of the contacts C and each of the discharging contacts b ON, such that the battery B1˜Bn on each charging circuit 121˜124 is in a series-connected and combined discharging mode. The discharging button 40 controls the ON/OFF state of the discharging current I_{d} by voltage regulator circuit 50,

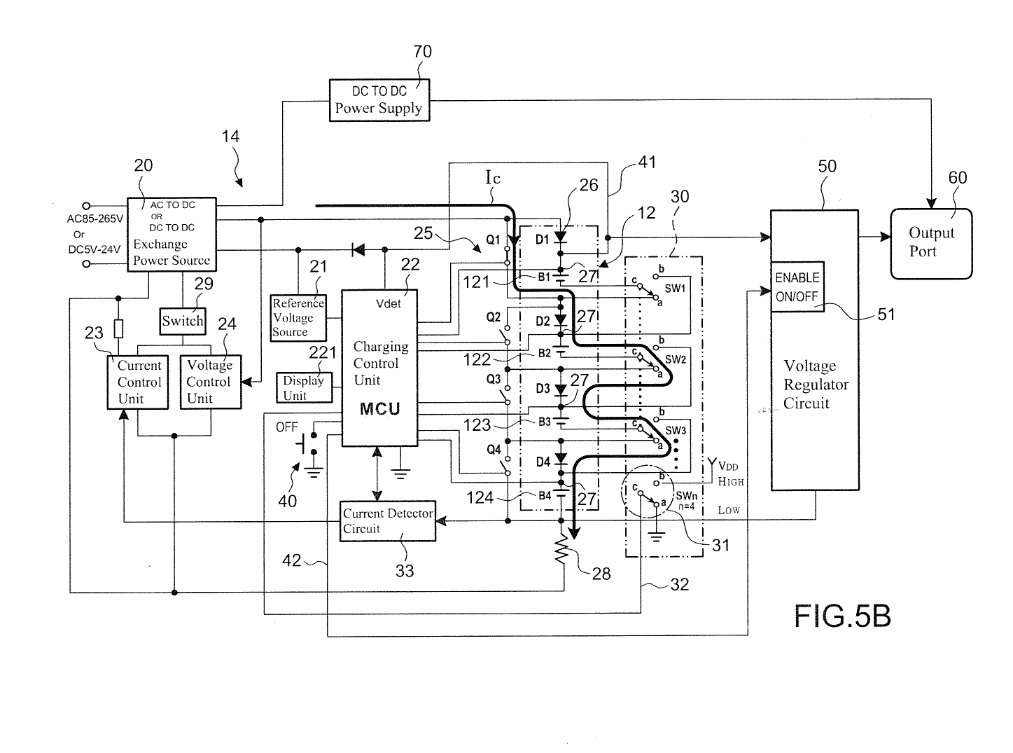

FIGS. 5A˜5D illustrate the series charging arrangement in accordance with the present invention. FIG. 5A shows the circuit to charge four batteries B₁˜B₄ in the charging base 12 by the charging current Ic. Q₁˜Q₄ of the switch element 25 are all switched in the OFF state. Therefore, the flow direction of the charging current Ic is shown in the drawing. The charging current Ic flows through each of the series batteries B₁˜B₄. When the battery B₁ is fully charged, the charging control unit 22 detects the charging voltage at the detection point 27 as LOW such that the first switch element Q₁ is switched ON. At this time, the charging current Ic is shown in FIG. 5B. The battery B₁ won't be charged by the charging current Ic again. The charging current Ic flows downward for a further charging process. When the battery B₂ is fully charged, the switch element Q₂ of the charging circuits 122 is switched ON (see FIG. 5C), and so on. When all of the batteries B₁˜B₄ are fully charged (see FIG. 5D), all of the switch elements Q₁˜Q₄ are switched ON. Meanwhile, the charging current Ic can be adjusted by the current detection component 28 for slightly charging all of the batteries. The batteries B₁˜B₄ of the present invention are connected in series for charging but each of the batteries B₁˜B₄ has a separate detection circuit. Only the separate detection way for the charged batteries can make sure if each of the batteries is really charged in a full capacity. Meanwhile, an excessive charging or a non-full charging can be prevented. Moreover, the series charging with separate detection ensures a better charging efficiency. Therefore, the invention is a continuation of the feature of the previous invention. That is, the charging circuits 121˜424 are instantly and synchronously combined in a discharging circuit by the charging/discharging switch set 30 when the batteries B₁˜B₄ in the charging base 12 are fully charged. In this way, the stored electric energy can be effectively released for use.

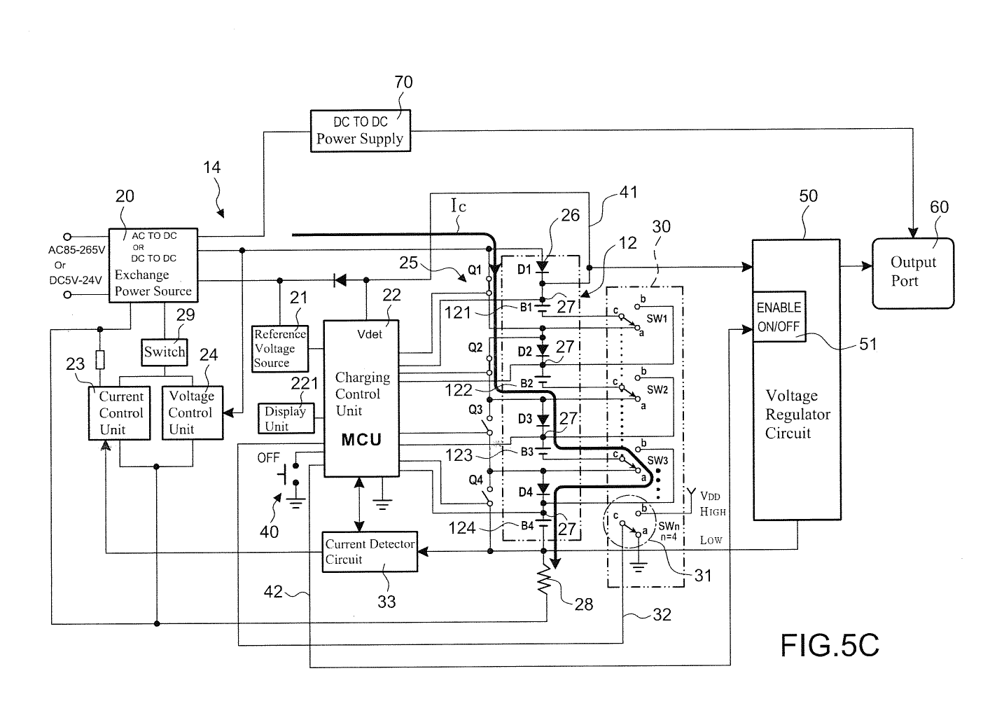

Based on the technical features disclosed, when the batteries B₁˜B₄ are set in the charging base 12, the charging/discharging control switch 31 is in a LOW voltage level, and the charging control unit 22 turns each of the contacts a ON. At the same time, the charging/discharging switch set 30 switches to a charging mode, such that each of the batteries B₁˜B₄ is synchronously charged. When the batteries B₁˜B₄ are fully charged, the charging/discharging control switch 31 is in a HIGH voltage level, and the charging control unit 22 turns each of the contacts b ON. At the same time, the charging/discharging switch set 30 switches to a discharging mode, such that each of the batteries B₁˜B₄ is in a series-connected and combined discharging mode as shown in FIG. 6.

To charge the electronic devices, then press the discharging button 40. At this time, the discharging control unit 22 controls a discharging (enable) switch 51 built in the voltage regulator circuit 50 to be in the ON state, such that the discharging current I_{d} is output to the output port 60 for the use of the external electronic devices.

The MCU integrated series-connected charger/discharger in accordance with the aforesaid preferred embodiment is not a limitation. That is, the structure of the MCU integration charger/discharger in accordance with the present invention can be a parallel-connected charger as shown in the FIG. 10. However, they have the same control way and the same discharging mode, and thus will not be described here.

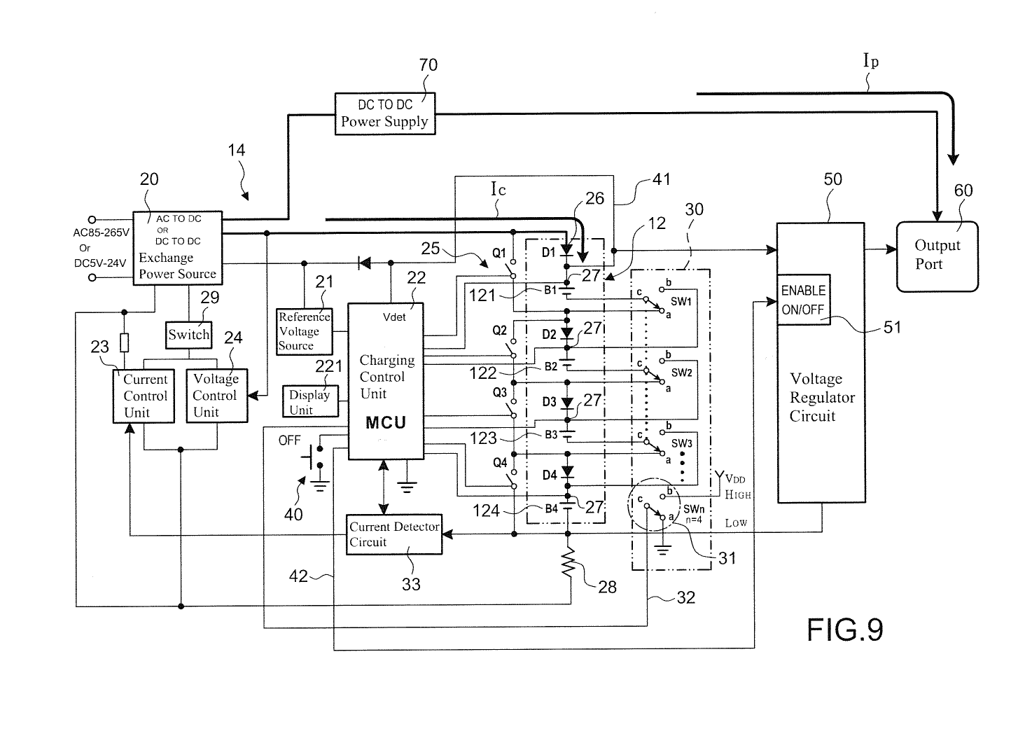

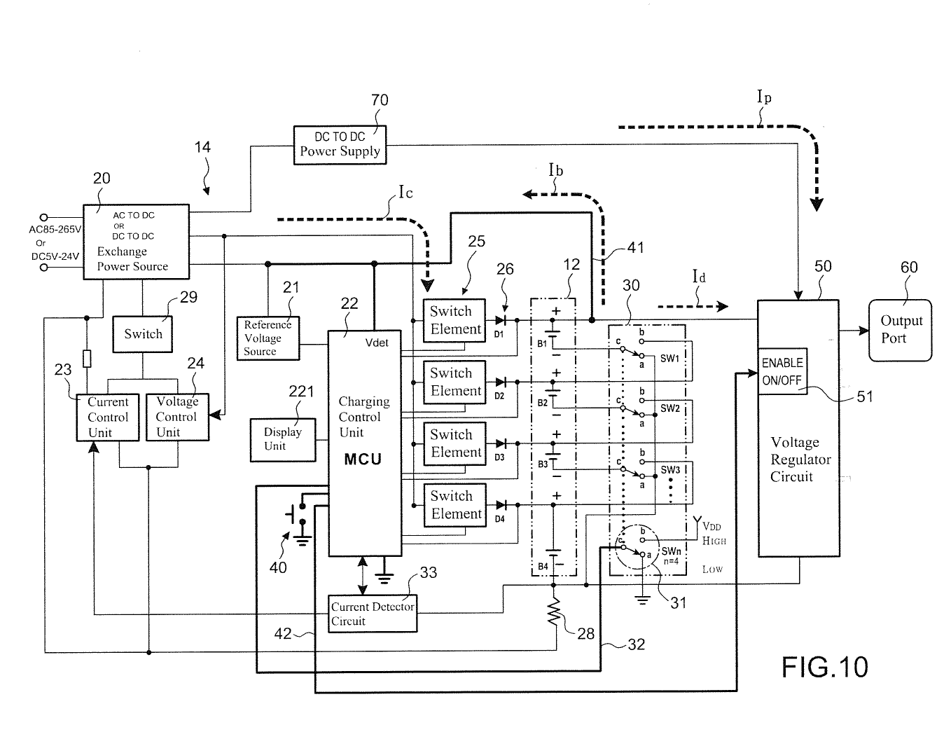

With the foregoing structures as shown in FIGS. 11 and 12, when the batteries B₁˜B₄ are set in the charging base 12, the charging/discharging control switch 31 is in a LOW voltage level, and the charging control unit 22 controls n sets of switching units SW₁˜SWₙ to synchronously turn each of the contacts c and each of the contacts a ON. With reference to FIGS. 5A to 5B, the batteries B₁˜B₄ are charged by the charging current I_{c}, and each of the batteries B₁˜B₄ in the charging base 12 is an independent separate charging circuit. When the batteries B₁˜B₄ are fully charged, the charging/discharging control switch 31 is in a HIGH voltage level, and the charging control unit 22 controls n sets of switching units SW₁˜SWₙ to synchronously turn each of the contacts c and each of the contacts b ON, such that each of the batteries B₁˜B₄ in the charging base 12 stops charging. At the same time, the fully-charged batteries B₁˜B₄ are formed as a battery charger 10A for the use of the electronic devices.

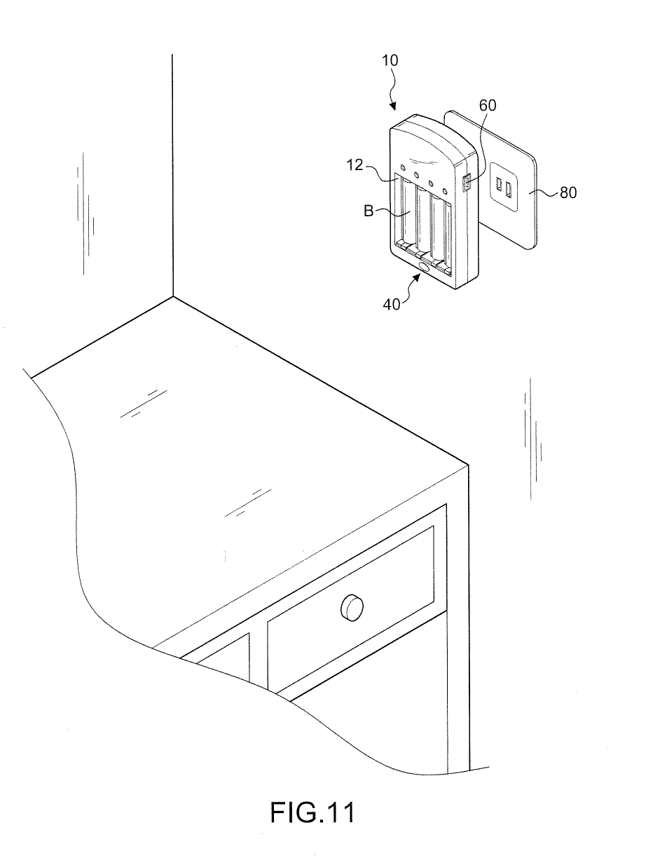

With reference to FIGS. 6 and 13, when the discharging button 40 is switched ON, the charging control unit 22 controls the discharging switch 51 built in the voltage regulator circuit 50 to be in the ON state by the third connecting wire 42, such that each fully-charged battery B₁˜B₄ of the charging base 12 is connected in series. At the same time, the discharging current I_{d} outputting to the USB output port 60 after regulated, and provided DC power for charging electronic devices, so as to form a discharger 10B.

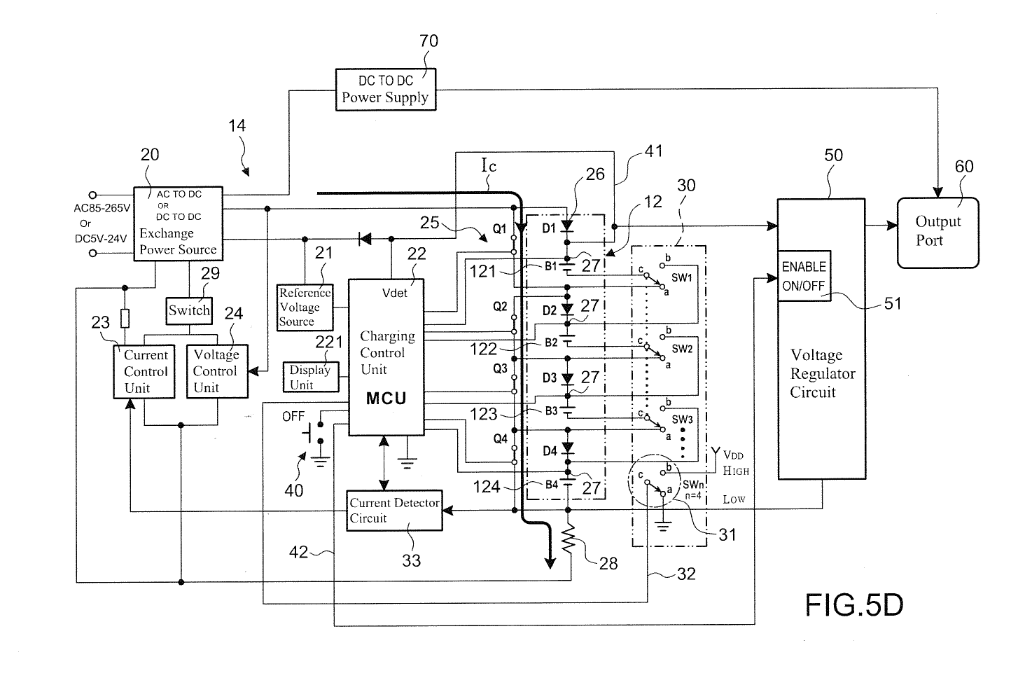

With reference to FIG. 7, when each batteries B₁˜B₄ in the charging base 12 is fully charged and not yet discharged, the discharging current I_{d} of a part of the batteries becomes feedback current I_{b} feeding back to the reference voltage source 21 and the charging control unit 22 by the second connecting wire 41 to supply the basic electric power.

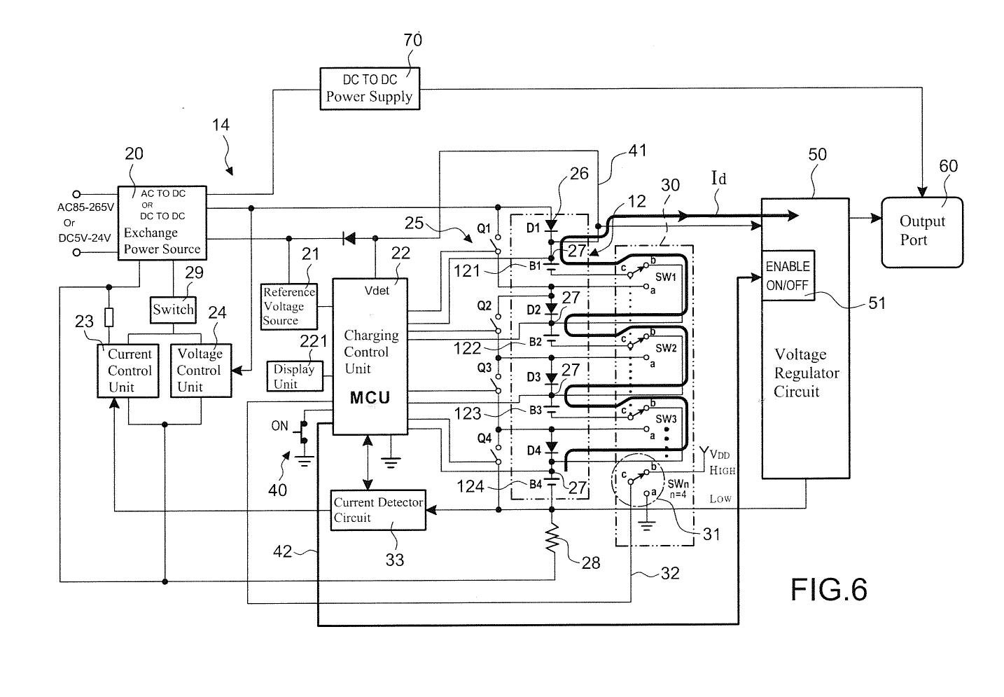

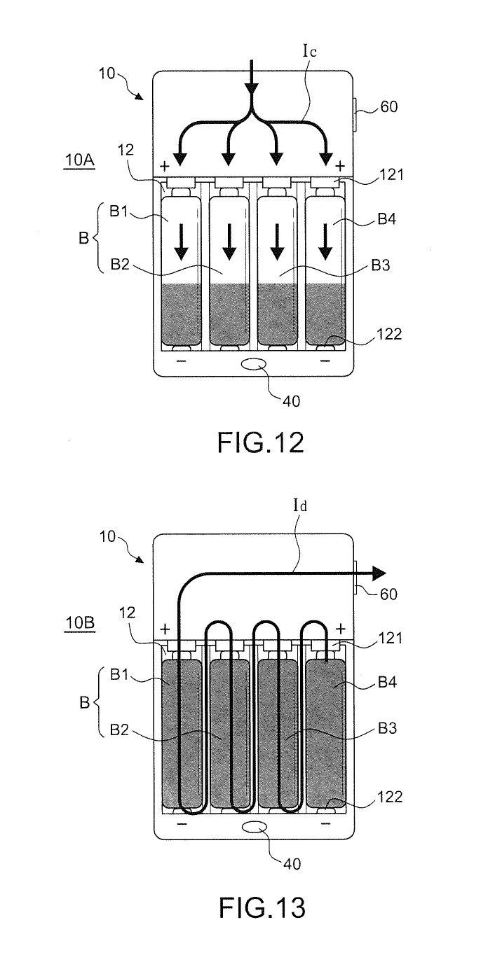

With reference to FIGS. 8 and 14, the exchange power source 20 is externally coupled to a DC To DC power supply 70. The DC To DC power supply 70 is connected to the USB output port 60 for supplying power supply current Iₚ, such that the charger becomes an adaptor 10C which supplies DC charging power source when the battery in the charging base 12 is low or there is no battery in the charging base 12.

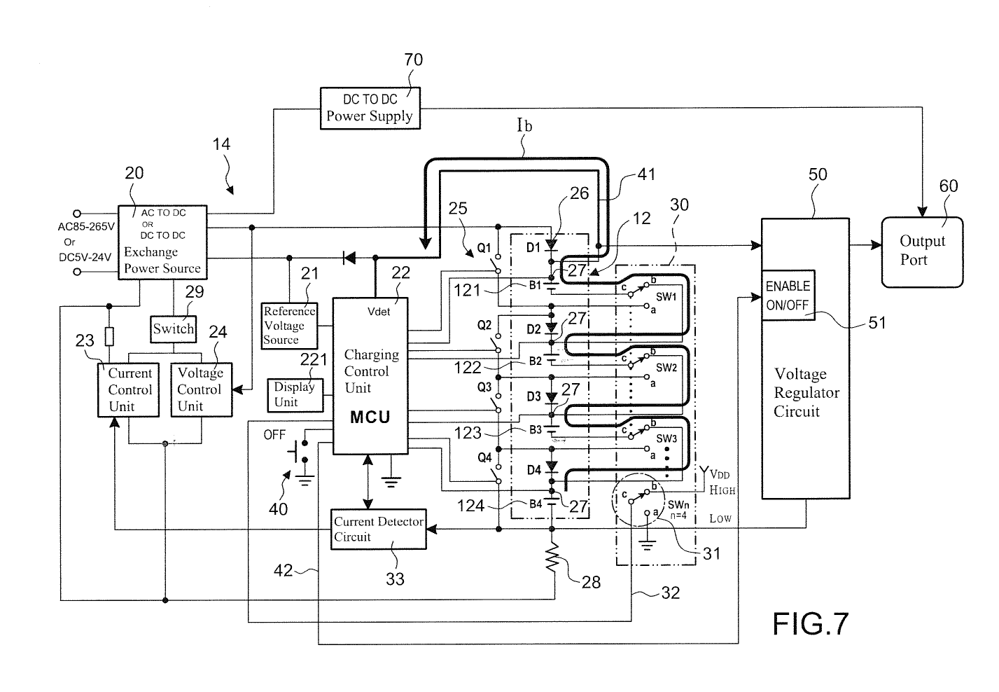

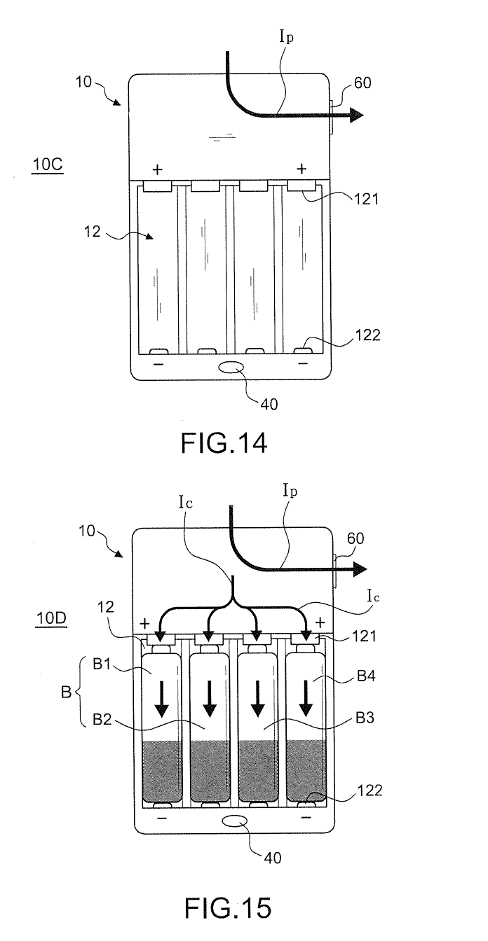

With reference to FIGS. 9 and 15, the present invention can provide not only a power supply current Iₚ to becomes the adaptor 10C but also provide a charging current I_{c} for charging the batteries B₁˜B₁ in the charging base 12 at the same time, so as to become an adaptor/charger 10D without affecting the power supply of the electronic product during the charging process.

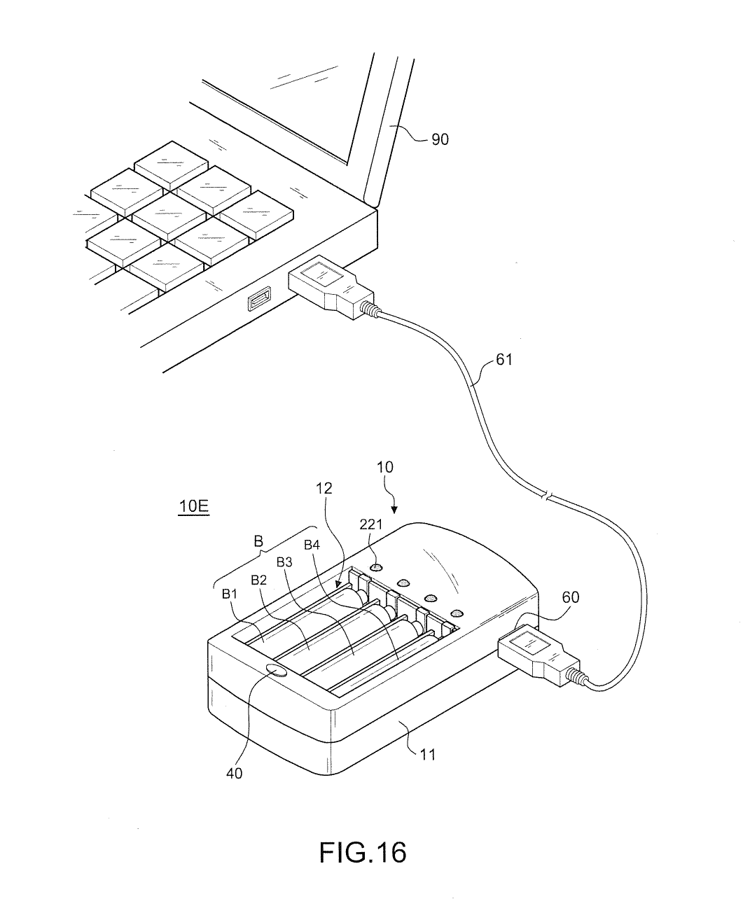

With reference to FIG. 16, the required electric power supplied from the USB output port 60 can be outputted to a portable electronic product 90 through a transmission cable 61, so as to form a portable power or an emergency power supply 10E.

In summation, the present invention uses an MCU and a charging/discharging switch set to integrate the features of an “independent separate charging circuit” and a “series-connected and combined discharging circuit” to synchronously, control the ON/OFF of the charging and discharging circuits in the same charging base. The invention not only provides a convenient operation, but also overcomes the shortcomings of the conventional charger and achieves the effects of enhancing the charging and discharging performance, and integrating several functions into the same charger to improve its practicability.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An MCU integration battery charger/discharger, more particularly to a charger design with an MCU for controlling each of the batteries into an independent separate charging mode or a series-connected and combined synchronous discharging mode, comprising:
a casing, containing a charging component, and having a charging base disposed on a surface of the casing, a plurality of charging compartments formed in the charging base for placing a plurality of AA or AAA batteries respectively, and an end of the charging compartment being a positive terminal, and the other end of the charging compartment being a negative terminal, thereby creating a charging circuit, and the casing having a plug connectible to an external power source;
a charging circuit, including an exchange power source for converting an AC or DC power to a DC power and supplying a reference voltage source to a charging control unit, and a current control unit and a voltage control unit being interposed between the charging control unit and the exchange power source, thereby creating a charging circuit for charging the batteries in the charging base;
each charging circuit of the batteries within the charging base being connected in parallel with a switch element, and an anti-adverse-current element being interposed between the switch element and the positive terminal of the battery;
a charging/discharging switch set provided for switching the charging circuits into the charging mode or the discharging mode, and the charging/discharging switch set having a number n−1 of switching units (SW₁˜SWₙ₋₁) corresponding to the charging circuits n in the charging base such that a switching unit is respectively interposed between two charging circuits, and wherein the last switching unit (SWn) of the charging/discharging switch set is an independent charging/discharging control switch, and wherein each of the switching units (SW₁˜SWₙ) has three contacts a, b, c, and wherein the contact a of the switching units (SW₁˜SWₙ₋₁) is electrically connected to the switch element of the corresponding charging circuits and to the front end of the anti-adverse-current element of the next charging circuits, and wherein the contact b is electrically connected to the positive terminal of the battery of the next charging circuit, and wherein the contact c is electrically connected to the negative terminal of the battery of the corresponding charging circuit, and wherein the contact a of the switching unit (SWₙ) serving as the charging/discharging control switch is not only a ground connection but a charging control terminal, and the contact b is a discharging control terminal connecting to a power control terminal (V_{DD}), and the contact C is connected to the charging control unit by a first connecting wire;
a voltage regulator circuit, being coupled to a positive terminal of the first charging circuit/compartment in the charging base for boosting or stepping down the series-connected and combined discharging current of each battery to a predetermined DC voltage;
an output port, coupled to an output terminal of the voltage regulator circuit;
a feedback current, being fed back discharging current of a part of the battery from the output terminal of the charging base to the reference voltage source and the charging control unit by a second connecting wire while the battery is discharging; and
a discharging button, exposed from a surface of the casing, and electrically connected to the charging control unit while the charging control unit is connected to the voltage regulator circuit by a third connecting wire for controlling the discharging current outputting the voltage regulator circuit to the output port;
whereby, when the battery is set in the charging base, the charging/discharging control switch is in a LOW voltage level, and the charging control unit controls n sets of switching units (SW₁˜SWₙ) to synchronously turn each contact C and each contact a ON, such that each battery of the charging circuit is in a separate detection charging mode, and when the each battery is fully charged, the charging/discharging control switch is in a HIGH voltage level, and the charging control unit controls n sets of switching units (SW₁˜SWₙ) to synchronously turn each contact C and each contact b ON, such that each battery of the charging circuit is in a series-connected and combined synchronous discharging mode, and the discharging button is provided for controlling the ON/OFF of the discharging current from the voltage regulator circuit.

2. The MCU integration battery charger/discharger as claimed in claim 1, wherein the charging base has n sets of charging circuits, and n is equal to 2, 4 or 8, and the n−1 sets of the switching units (SW₁˜SWₙ₋₁) corresponding to the charging/discharging switch set is equal to 1 set, 3 sets or 7 sets, and the 1 set, 3 sets or 7 sets plus the last n^{th} set of independent switching unit (SW) form the charging/discharging control switch.

3. The MCU integration battery charger/discharger as claimed in claim 2, wherein the charging/discharging switch set is constructed as an electronic type switch which is comprised of a MOSFET or a logic circuit.

4. The MCU integration battery charger/discharger as claimed in claim 1, wherein the exchange power source is externally coupled to a DC To DC power supply for supplying the power to the output port.

5. The MCU integration battery charger/discharger as claimed in claim 1, wherein the anti-adverse-current element of the charging circuit is comprised of a diode or a MOSFET, and wherein the switch element connected in parallel with the charging circuit is comprised of a MOSFET.

6. The MCU integration battery charger/discharger as claimed in claim 1, wherein the negative terminal of the charging base comprises a current detection component, and the current detection component is a resistor coupled to the exchange power source.

7. The MCU integration battery charger/discharger as claimed in claim 6, wherein a current detector circuit is composed between the current detection component and the current control unit, and the current detector circuit is electrically connected to the current control unit.

8. The MCU integration battery charger/discharger as claimed in claim 1, wherein a discharging (enable) switch is built in the voltage regulator switch.

9. The MCU integration battery charger/discharger as claimed in claim 1, wherein a plurality of batteries within the charging base are connected in parallel or in series while charging.
